(19) United States
(12) Patent Application Publication
(10) Pub. No.: US 2009/0040614 A1
(43) Pub. Date: Feb. 12, 2009

(54) Dispersive Filter

(76) Inventor: Michael J. Hammond, North Yorkshire (GB)

Correspondence Address: Silicon Valley Patent Group LLP, 18805 Cox Avenue, Suite 220, Saratoga, CA, 95070, US

(21) Appl. No.: 11/835,294

(22) Filed: Aug. 7, 2007

(51) Int. Cl. G02B 27/44; G02B 5/04

(52) U.S. Cl. 359/566; 359/565

(57) ABSTRACT

A dispersive filter includes two dispersion systems with an intermediate slit between them. The two dispersion systems have similar but mirror image dispersion characteristics at the plane of the intermediate slit and are configured so that the entrance port of the dispersive filter is polychromatically imaged on the exit port. The intermediate slit passes blocks selected wavelengths and transmits the remaining dispersed wavelengths from the first dispersion system to the second dispersion system. The second dispersion system combines the dispersed beam that passes through the intermediate slit to form an output beam, which is focused on the exit port. In this manner, the radiance of the input radiation is preserved ignoring losses caused by the optical elements and the blocked wavelengths.

### FIELD OF THE INVENTION

The present invention is related to a dispersive filter that emits polychromatic light and, in particular, to a dispersive filter that maintains the radiance of the input radiation.

### BACKGROUND

Conventional dispersive monochromators use prisms or gratings to disperse light over a region of space and selectively remove wavelengths from the spectrum by blocking the wavelengths and passing desired wavelengths through slits or apertures. One type of dispersive monochromator is a double monochromator, which connects two monochromators in series to improve the stray light level performance. As the name suggests, dispersive monochromators emit monochromatic light.

Dispersive monochromators, including double monochromators, generally suffer from a loss of radiance. The output of the monochromator is dispersed spectrally and the area of illumination immediately inside the exit aperture of a dispersive monochromator is much greater than the area of illumination immediately inside the entrance aperture. Thus, the radiance of the light (integrated over the spectrum) must be lower at the exit aperture than it is at the entrance aperture.

Accordingly, dispersive monchromators, including double monochromators, are not suitable for applications where it is desirable to maintain the radiance (integrated over the pass-band of the instrument) from the entrance aperture to the exit aperture.

### SUMMARY

In accordance with an embodiment of the present invention, a dispersive filter uses two dispersion systems coupled in series with an intermediate slit between the two. Each dispersion system includes a dispersive element, such as a diffraction grating or a prism, and have similar but mirror image dispersion characteristics at the plane of the intermediate slit. The two dispersion systems are configured so that an entrance port of one of the dispersion systems is polychromatically imaged on the exit port of the other dispersion system. The first dispersion system disperses the wavelengths of input radiation to form a dispersed beam that is focused on the intermediate slit. The intermediate slit blocks selected wavelengths and passes the remaining wavelengths of the dispersed beam to the second dispersion system. The second dispersion system combines the remaining wavelengths of the dispersed beam to form an output beam, which is focused on the exit port. In this manner, the radiance of the input radiation is preserved ignoring losses caused by the optical elements and the blocked wavelengths.

### BRIEF DESCRIPTION OF THE DRAWINGS

FIG. 1 schematically illustrates a prism based dispersive filter, in accordance with an embodiment of the present invention.

FIG. 2A schematically illustrates for explanatory purposes the dispersion characteristics of the input portion and the output portion at the plane of the intermediate slit.

FIG. 2B schematically illustrates the dispersed beam produced by the input portion and the intermediate slit blocking a portion of the wavelengths in the dispersed beam.

FIG. 3 schematically illustrates a diffraction grating based dispersive filter, in accordance with another embodiment of the present invention.

### DETAILED DESCRIPTION

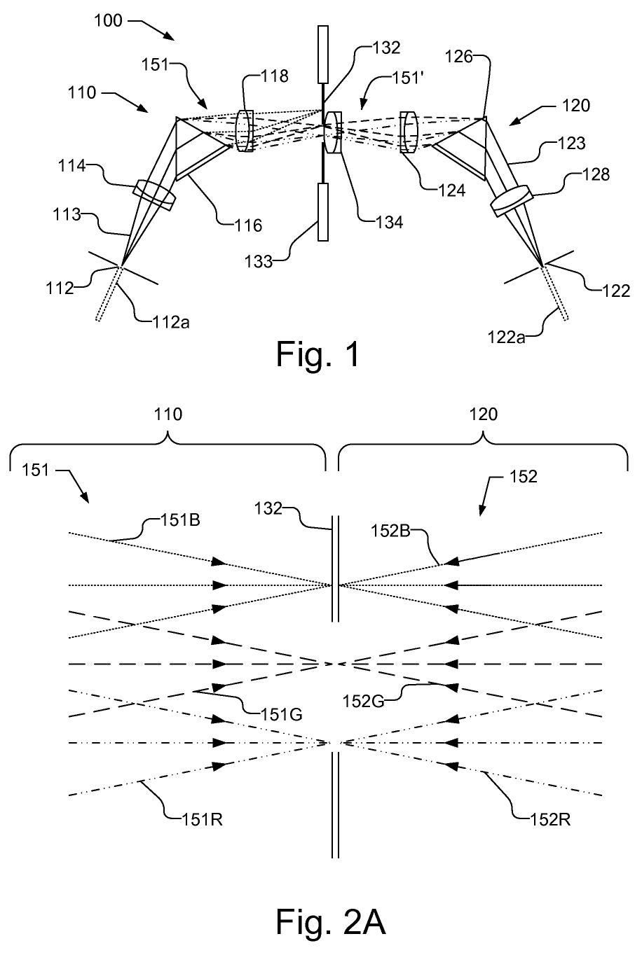

FIG. 1 schematically illustrates a prism based dispersive filter 100, in accordance with an embodiment of the present invention. The dispersive filter 100 is a polychromatic filter, in which only a limited part of a continuum is filtered and the remaining wavelengths are recombined with little or no loss of radiance with respect to the pass band of the instrument and ignoring losses caused by inefficiencies of optical elements.

Dispersive filter 100 is illustrated as including two dispersion systems, sometimes referred to herein as input and output portions 110 and 120, with an intermediate slit 132 and field lens 134 between them. While dispersive filter 100 is shown with the input and output portions 110 and 120 symmetrically arranged, it should be understood that symmetry is not required in accordance with the present invention as long as the input and output portions 110 and 120 have similar dispersions characteristics as measured at the plane of the intermediate slit 132 and include pupil matching so that the exit pupil of the input portion is imaged (polychromatically) on the entrance pupil of the output portion.

The input portion 110 includes an entrance port 112, which may be an aperture, such as a slit as illustrated in FIG. 1, or the output end face of an optical fiber 112a illustrated with broken lines. Light passing through the entrance port 112 forms an input beam 113 and is directed to a collimating optical element 114, which collimates the input beam 113. A wavelength dispersing element, such as prism 116 or a diffraction grating, receives the collimated input beam and spatially disperses the wavelengths to form a dispersed beam 151. The dispersed beam 151 is focused onto the plane of the intermediate slit 132 by an optical element 118. The intermediate slit 132 transmits a modified dispersed beam 151′, which may have a portion of the wavelengths removed.

In the output portion 120 of the dispersive filter 100, a collimating optical element 124 collimates the dispersed beam 151′ after it has passed through the intermediate slit 132. The output portion 120 includes a wavelength dispersing element, such as prism 126 or a diffraction grating, that is configured and positioned so that the spectral characteristics of prism 126 and prism 116 are mirror image at the plane of the intermediate slit 132. The prism 126, thus, receives the dispersed beam 151′ from collimating optical element 124 and reverses the dispersion of the wavelengths to form an output beam 123. The resulting output beam 123 is focused by an optical element 128 on the exit port 122, which may be an aperture, such as a slit as illustrated in FIG. 1, or the input end face of an output fiber 122a illustrated with broken lines.

By way of example, the optical elements 114, 118, 124, and 128 may be achromatic doublet lenses, e.g., such as that produced by produced by Edmund Optics as part number 32-323, and the prisms 116 and 126 produced by Edmund Optics as part number 47-284.

The intermediate slit 132 acts as an port and is configured to eliminate selected wavelengths from the dispersed beam 151, by blocking those wavelengths and passing the remaining wavelengths. In one embodiment, one or more actuators 133 may be coupled to the intermediate slit 132 to vary the width, e.g., from 20 mm to 500 mm, and/or position of the slit 132 so that the wavelengths may be selectively blocked or passed. By way of example, one actuator may alter the width of the slit 132 and another actuator may vary the position, or alternatively, one actuator may adjust one side of the slit and the other actuator may adjust the other side to vary the width and/or position of the slit. Thus, for example, only the wavelengths at one or both ends of the light spectrum may be selected to be filtered while the remaining light is passed. By way of example, 20% to 99% of the wavelengths in the dispersed beam 151 are passed by the intermediate slit 132 and emitted from the dispersive filter 100. The more wavelengths that are permitted to pass the intermediate slit 132, the greater the benefit of preserved radiance for the dispersive filter 100.

In general, the spectrum of the dispersed beam 151 will be dispersed in angle as well as position at the intermediate slit 132, which if not controlled will cause a loss of radiance for the dispersive filter 100. A field lens 134, e.g., in the form of an achromatic doublet lens such as that described above, at or near the intermediate slit 132 can be used to negate the dispersion in angle.

It should be understood that if desired the input portion and the output portion may be composed of the same optical components. A system of mirrors at the intermediate slit 132 may be used to reflect the dispersed beam back to the dispersive element, which recombines the wavelengths to form the output beam. The output beam is focused on an exit port that is separate from the entrance port. Mirrors appropriately positioned in the beam path may be used to separate the entrance port and the exit port, as will be understood by those skilled in the art.

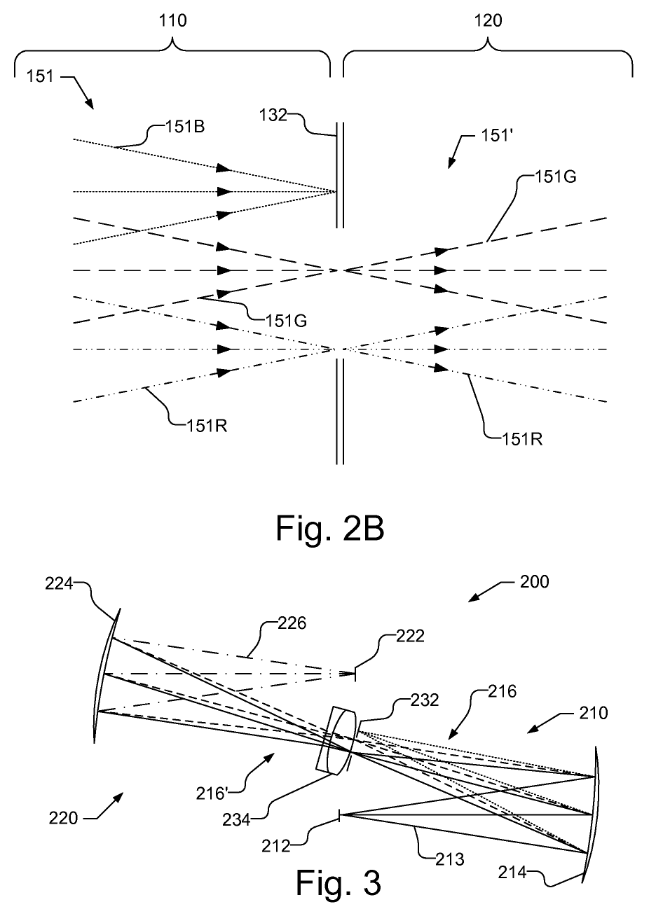

FIG. 2A schematically illustrates for explanatory purposes the dispersion characteristics of the input portion 110 and the output portion 120 at the plane of the intermediate slit 132. FIG. 2A illustrates the relative configuration of the dispersed beam 151 produced by the input portion 110 at the plane of the intermediate slit 132 along with the configuration of a hypothetical spectrum 152 at the plane of the intermediate slit 132 that would be produced by the output portion 120 if light were to enter the exit port 122. It should be understood that in operation, light leaves the system through the exit port 122 and that FIG. 2A shows the hypothetical spectrum 152 merely to explain the similar but mirror image dispersion characteristics of the input portion 110 and the output portion 120 at the plane of the intermediate slit 132.

The input portion 110 produces the dispersed beam 151, which has a plurality of wavelengths, only three of which are illustrated in FIG. 2A as 151R, 151G, and 151B. The optical element 118 focuses the dispersed beam 151 onto the plane of the intermediate slit 132. As can be seen in FIG. 2A, only wavelengths 151R and 151G pass through the intermediate slit 132 and wavelength 151B is blocked by the intermediate slit 132.

If white light were to enter the exit port 122 of the output portion 120, the output portion 120 would also produce a wavelength-dispersed beam 152 with the optical element 124 (and field lens 134) focusing the wavelengths 152R, 152G, and 152B on the plane of the intermediate slit 132, wherein 152R, 152G, and 152B have the same wavelengths as 151R, 151G, and 151B, respectively. As can be seen in FIG. 2A, wavelengths 152R and 152G would pass through the intermediate slit 132 and wavelength 152B would be blocked by the intermediate slit 132. Moreover, as can be seen in FIG. 2A, the wavelengths 151R and 152R are focused at the same position on the plane of the intermediate slit 132, as are wavelengths 151G/152G and wavelengths 151B/152B. In other words, the wavelength projected by the input portion 110 onto a particular point in the plane of the intermediate slit 132 will be the same wavelength that the output portion 120 would project at that particular point. Thus, the dispersion characteristics of the input portion 110 and the output portion 120 at the plane of the intermediate slit 132 are said to be the same and mirror image. It should be understood that in practice, a small amount of deviation in the focal position of the wavelengths on the plane of the intermediate slit 132 may be tolerated.

FIG. 2B schematically illustrates the dispersed beam 151 produced by the input portion and the intermediate slit blocking a portion of the wavelengths in the dispersed beam 151 resulting in the modified dispersed beam 151′ during operation of the dispersive filter 100. FIG. 2B differs from FIG. 2A in that FIG. 2B illustrates the operation of the dispersive filter 100 with the output portion 120 receiving the dispersed beam 151′, as opposed to illustrating a hypothetical beam 152 that would be produced if light were to enter the exit port 122 of the output portion 120 as shown in FIG. 2A.

As can be seen in FIG. 2B, the wavelengths 151G and 151R from the input portion 110 pass through the intermediate slit 132 to form the modified dispersed beam 151′ and are received by the output portion 120. The wavelength 151B, however, is blocked by the intermediate slit 132. All of the light that is passed through the intermediate slit 132, however, will be focused by the output portion 120 into a single place at the exit port 122. Thus, if the intermediate slit 132 is set wide enough that none of the spectrum where to be blocked, the entrance port 112 of the input portion 110 will be imaged onto the exit port 122 of the output portion 120 for the entire spectrum.

It should be understood that FIGS. 2A and 2B illustrate only three wavelengths for illustrative purposes and that in operation a continuous spectrum of light is produced. Moreover, the intermediate slit 132 may be configured to block only a small portion of the wavelengths or a large portion of the wavelengths, and may block wavelengths on both ends of the spectrum if desired.

FIG. 3 schematically illustrates a grating based dispersive filter 200, in accordance with another embodiment of the present invention. The principle of operation of the dispersive filter 200 is similar to the dispersive filter 100 shown in FIG. 1 in that the dispersion characteristics of the of the input portion 210 and the output portion 220 at the intermediate slit 232 are the same and mirror image. Accordingly, the dispersive filter 200 maintains the radiance of the input radiation integrated over the pass band and ignoring losses caused by the optical elements.

As illustrated in FIG. 3, the input portion 210 includes a concave grating 214 that receives the input light 213 from the entrance port 212 and produces a dispersed beam 216 with wavelengths spatially dispersed and focused on the plane of the intermediate slit 232. The intermediate slit 232 may selectively block one or more of the wavelengths in the wavelength-dispersed beam 216. The unblocked wavelengths pass through the intermediate slit 232 to form the modified dispersed beam 216′. In the output portion 220, the wavelengths in the modified dispersed beam 216′ are combined by another grating 224 to form an output beam 226. The output beam 226 is focused by the grating onto an exit port 222.

Additional optical elements may be used if desired. For example, a field lens 234 may be positioned at or near the intermediate slit 232 to negate any dispersion in angle of the wavelength-dispersed beam 216. Additional optical elements may be used, e.g., for focusing or collimating the light within the input portion 210 or output portion 220.

Although the present invention is illustrated in connection with specific embodiments for instructional purposes, the present invention is not limited thereto. Various adaptations and modifications may be made without departing from the scope of the invention. Therefore, the spirit and scope of the appended claims should not be limited to the foregoing description.

What is claimed is:

1. A dispersive filter comprising:
an entrance port through which input radiation with a first range of wavelengths is transmitted;
a first dispersive element positioned to receive the input radiation, the first dispersive element configured to disperse the wavelengths of the input radiation to produce a wavelength-dispersed beam with the first range of wavelengths;
an intermediate slit positioned to receive the wavelength-dispersed beam which is focused on a plane of the intermediate slit, the intermediate slit transmitting a second range of wavelengths of the wavelength-dispersed beam to form a modified wavelength-dispersed beam;
a second dispersive element positioned to receive the modified wavelength-dispersed beam, the second dispersive element is configured to have a dispersion characteristic that is mirror image to a dispersion characteristic of the first dispersive element at the plane of the intermediate slit, the second dispersive element combining the wavelengths of the modified wavelength-dispersed beam to produce an output beam having the second range of wavelengths; and
an exit port positioned to receive the output beam from the second dispersive element and to emit the output beam having the second range of wavelengths.

2. The dispersive filter of claim 1, further comprising a field lens positioned between the first dispersive element and the second dispersive element and is configured to correct angular dispersion of the wavelength-dispersed beam.

3. The dispersive filter of claim 1, further comprising:
a first lens positioned between the first dispersive element and the intermediate slit, the first lens focuses the wavelength-dispersed beam on the plane of the intermediate slit; and
a second lens positioned between the intermediate slit and the second dispersive element, the second lens collimates the modified wavelength-dispersed beam.

4. The dispersive filter of claim 3, further comprising:
a third lens positioned between the entrance port and the first dispersive element, the third lens collimates the input radiation to be received by the first dispersive element; and
a fourth lens positioned between the second dispersive element and the exit port, the fourth lens focusing the output beam on a plane of the exit port.

5. The dispersive filter of claim 1, wherein the first dispersive element focuses the wavelength-dispersed beam on the plane of the intermediate slit and wherein the second dispersive element focuses the output beam on a plane of the exit port.

6. The dispersive filter of claim 1, wherein at least one of the first dispersive element and second dispersive element is one of a prism and a diffraction grating.

7. The dispersive filter of claim 1, wherein at least one of the entrance port and exit port is a slit.

8. The dispersive filter of claim 1, wherein at least one of the entrance port and exit port is an end face of a fiber optic cable.

9. The dispersive filter of claim 1, further comprising at least one actuator coupled to the intermediate slit, the actuator configured to adjust a width of the intermediate slit to alter the wavelengths that are passed through the intermediate slit.

10. A method of filtering radiation, the method comprising:
receiving input radiation having a first range of wavelengths;
dispersing the wavelengths of the input radiation to form a dispersed beam with the first range of wavelengths;
focusing the dispersed beam on a plane of an port, wherein a second range of wavelengths that is smaller than the first range is passed through the port;
reversing the dispersion of the second range of wavelengths in the dispersed beam to form an output beam;
focusing the output beam having the second range of wavelengths; and
emitting the output beam with the second range of wavelengths.

11. The method of claim 10, wherein dispersing the wavelengths of the input radiation and focusing the dispersed beam are performed with a first diffraction grating and wherein combining the second range of wavelengths in the dispersed beam and focusing the output beam are performed with a second diffraction grating.

12. The method of claim 10, wherein dispersing the wavelengths of the input radiation and reversing the dispersion of the second range of wavelengths in the dispersed beam to form an output beam is performed with the same wavelength dispersion element.

13. The method of claim 10, further comprising adjusting at least one of the size and the position of the port to vary the wavelengths that are passed through.

14. The method of claim 10, wherein the input radiation is received through an entrance port and the output beam is emitted through an exit port, and wherein focusing the output beam having the second range of wavelengths comprises focusing the output beam on the plane of the exit port so that the entrance port is imaged on the exit port.

15. A dispersive filter comprising:
a first dispersive system having an entrance port that receives input radiation having a first range of wavelengths, and a first wavelength dispersive element that spatially disperses the wavelengths of the input radiation to form a dispersed beam;
a second dispersive system having an exit port and a second wavelength dispersive element, the second wavelength dispersive element receives at least a portion of the dispersed beam having a second range of wavelengths and combines the second range of wavelengths into an output beam that is emitted through the exit port, wherein the first dispersive system and the second dispersive system are configured so that the entrance port is polychromatically imaged on the exit port with the second range of wavelengths; and
an intermediate slit positioned between the first dispersive element and the second dispersive element, wherein the at least a portion of the dispersed beam is transmitted by the intermediate slit, wherein the first dispersive system has a first dispersion characteristic and the second dispersive system has a second dispersion characteristic, the first dispersion characteristic being mirror image of the second dispersion characteristic at a plane of the intermediate slit.

16. The dispersive filter of claim 15, further comprising a field lens positioned between the first dispersive element and the second dispersive element and is configured to correct angular dispersion of the dispersed beam.

17. The dispersive filter of claim 15, wherein at least one of the first wavelength dispersive element and the second wavelength dispersive element are prisms.

18. The dispersive filter of claim 17, wherein the first dispersion system further has a first lens positioned between the first wavelength dispersive element and the intermediate slit, the first lens focuses the dispersed beam on the plane of the intermediate slit; and wherein the second dispersion system further has a second lens positioned between the intermediate slit and the second dispersive element, the second lens collimates the at least a portion of the dispersed beam.

19. The dispersive filter of claim 18, wherein the first dispersion system further has a third lens positioned between the entrance port and the first wavelength dispersive element, the third lens collimates the input radiation to be received by the first wavelength dispersive element; and wherein the second dispersion system further has a fourth lens positioned between the second wavelength dispersive element and the exit port, the fourth lens focusing the output beam on a plane of the exit port.

20. The dispersive filter of claim 15, wherein at least one of the first wavelength dispersive element and the second wavelength dispersive element are diffraction gratings.

21. The dispersive filter of claim 20, wherein the first wavelength dispersive element focuses the dispersed beam on the plane of the intermediate slit and wherein the second wavelength dispersive element focuses the output beam on a plane of the exit port.

22. The dispersive filter of claim 15, wherein at least one of the entrance port and the exit port are one of a slit and a fiber optic cable.

23. The dispersive filter of claim 15, further comprising at least one actuator coupled to the intermediate slit, the at least one actuator configured to adjust a width of the intermediate slit to alter the wavelengths that are transmitted by the intermediate slit.
